(19) United States
(12) Patent Application Publication
(10) Pub. No.: US 2020/0364444 A1
(43) Pub. Date: Nov. 19, 2020

(54) INFORMATION PROCESSING APPARATUS AND METHOD OF AUTHENTICATION

(71) Applicant: FUJITSU LIMITED, Kawasaki-shi (JP)

(72) Inventors: TOSHIKAZU KANAOKA, Kawasaki (JP); Norio NAGAHAMA, Tokorozawa (JP); Yuki Yoshimura, Fukuoka (JP); Rieka Kouge, Kawasaki (JP)

(73) Assignee: FUJITSU LIMITED, Kawasaki-shi (JP)

(21) Appl. No.: 16/872,421

(22) Filed: May 12, 2020

(30) Foreign Application Priority Data
May 14, 2019 (JP) 2019-091593

(51) Int. Cl. G06K 9/00

(52) U.S. Cl. CPC G06K 9/00288; G06K 9/00362; G06K 9/00281; G06K 9/00926

(57) ABSTRACT

A non-transitory computer-readable recording medium has stored therein a program that causes a computer to execute a process, the process including: determining, when a distance from a sensor to a target person is equal to or greater than a threshold value, whether the target person satisfies a first criterion included in first reference information for each of the plurality of persons, the distance being detected by the sensor; capturing, when the distance is less than the threshold value, a first image of the target person by a camera provided in a vicinity of the sensor; and performing a face authentication process for the target person on the first image preferentially using second reference information corresponding to the first reference information including a second criterion determined to be satisfied by the target person.

### CROSS-REFERENCE TO RELATED APPLICATION

This application is based upon and claims the benefit of priority of the prior Japanese Patent Application No. 2019-91593, filed on May 14, 2019, the entire contents of which are incorporated herein by reference.

### FIELD

The embodiments discussed herein are related to an information processing apparatus and a method of authentication.

### BACKGROUND

An authentication camera that captures a face image and authenticates a person's face is known.

Related techniques are disclosed in, for example, Japanese Laid-open Patent Publication No. 2007-303239.

### SUMMARY

According to an aspect of the embodiments, a non-transitory computer-readable recording medium has stored therein a program that causes a computer to execute a process, the process including: registering, for each of a plurality of persons, person information including first reference information for determining a feature other than that of a face of each person and second reference information for determining a feature of the face of each person in a memory; determining, when a distance from a sensor to a target person is equal to or greater than a threshold value, whether the target person satisfies a first criterion included in the first reference information for each of the plurality of persons, the distance being detected by the sensor; capturing, when the distance is less than the threshold value, a first image of the target person by a camera provided in a vicinity of the sensor; and performing a face authentication process for the target person on the first image preferentially using the second reference information corresponding to the first reference information including a second criterion determined to be satisfied by the target person.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of face authentication by a robot;

FIG. 2 is a diagram illustrating an example of a hardware configuration of the robot;

FIG. 3 is a diagram illustrating an example of a functional configuration of the robot;

FIG. 4 is a flowchart illustrating an example of a pre-registration process;

FIGS. 5A and 5B are diagrams for explaining an example of the pre-registration process;

FIG. 6 is a diagram illustrating an example of second reference information;

FIG. 7 is a diagram illustrating an example of first reference information;

FIG. 8 is a flowchart illustrating an example of a stepwise face authentication process;

FIG. 9 is a flowchart illustrating an example of the stepwise face authentication process;

FIGS. 10A to 10C are diagrams for explaining an example of the stepwise face authentication process;

FIG. 11 is a diagram for explaining an example of a change in the score;

FIGS. 12A and 12B are diagrams illustrating an example of the second reference information before and after learning;

FIGS. 13A to 13E are diagrams for explaining an example of the concept of the stepwise face authentication process; and

FIG. 14 is a diagram illustrating an example of an authentication processing system.

### DESCRIPTION OF EMBODIMENTS

When the number of face images to be matched with the face image to be authenticated increases, the number of matching times increases, so that there is a problem that it takes time to authenticate the face.

Hereinafter, embodiments will be described with reference to the accompanying drawings.

### First Embodiment

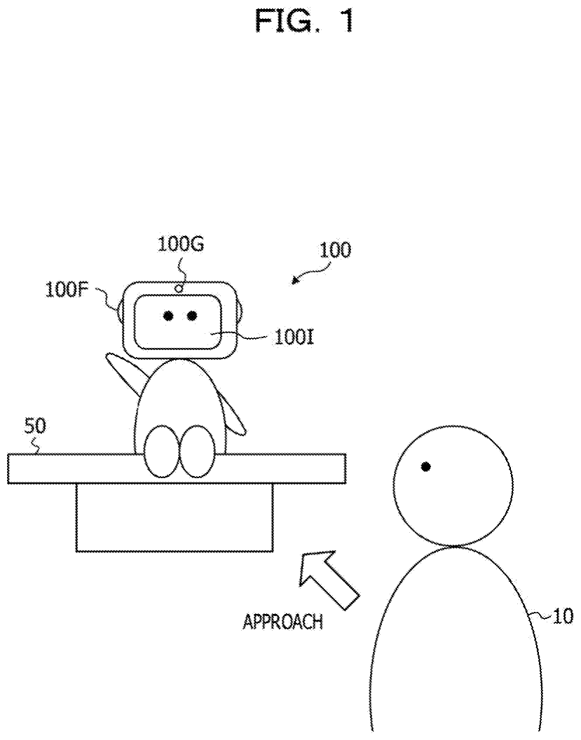

First, an outline of face authentication will be described with reference to FIG. 1. FIG. 1 is a diagram for explaining an example of face authentication by a robot 100. The robot 100 is an example of an authentication processing apparatus that executes face authentication process. As described above, in the present embodiment, the human-type robot 100 is employed as an example of the authentication processing apparatus. However, the authentication processing apparatus is not limited to the robot 100, for example. For example, a device capable of executing a face authentication process similar to the robot 100 according to the present embodiment (for example, a combination of various components, and the like) may be used as an authentication processing apparatus. The face authentication is a technique for confirming that a person is a specific person or a person himself or herself by using matching unlike face recognition for identifying a sex, an age, a mood, or the like from a face.

The robot 100 is mounted on, for example, a pedestal 50. The height of the pedestal 50 may be varied depending on the size of the robot 100. Depending on the size of the robot 100, the robot 100 may not be mounted on the pedestal 50.

The robot 100 includes a sensor 100F, a camera 100G, a display 100I, and the like. For example, the camera 100G is provided in the vicinity of the sensor 100F. At least one of the sensor 100F and the camera 100G may be separate from the robot 100. The sensor 100F includes a distance sensor. For example, an infrared distance sensor, a time-of-flight (TOF) sensor, or a laser range finder (LRF) may be used as the distance sensor. The distance sensor detects a distance from itself to an object moving within the search range, with respect to the search range in which the detection capability of the distance sensor is extended. Thus, the robot 100 may detect the distance from the robot 100 to the object. Since the camera 100G is provided in the vicinity of the sensor 100F, an object located at a position away from the distance sensor may be imaged as an object by the distance detected by the distance sensor.

In addition to the distance sensor, the sensor 100F may also include a depth sensor. Thus, the three-dimensional shape of the object may be detected. As a depth sensor, for example, an infrared depth sensor, a three-dimensional TOF camera, a laser range scanner (LRS), or the like may be used.

As illustrated in FIG. 1, when a person 10 approaches the robot 100 as the moving object, the robot 100 keeps track (tracking) of the person 10 as a face authentication target person, and continuously or intermittently detects the distance between the robot 100 and the person 10. Although the details will be described later, even when the person 10 approaches the robot 100, when the robot 100 continues to determine that the detected distance is equal to or greater than a predetermined threshold distance (for example, 1 m (meter)), the robot 100 determines the features other than that of the face of the person 10. Features other than that of the face of the person 10 include, for example, the height, clothing, sex, and the like of the person 10. When the robot 100 determines that the detected distance is less than the threshold distance as the person 10 further approaches the robot 100, the robot 100 determines a feature of the face using features other than that of the face. For example, the robot 100 determines the feature of the face by using, as candidates, persons whose features other than that of the face are matched in the determination using features other than that of the face. In this manner, the robot 100 executes the face authentication process for the person 10.

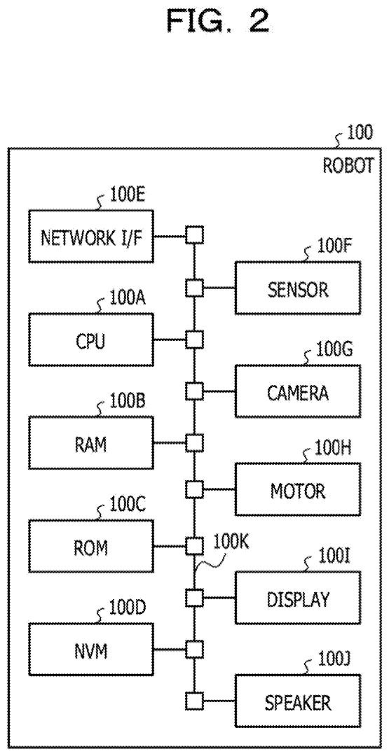

Next, a hardware configuration of the robot 100 will be described with reference to FIG. 2.

FIG. 2 is a diagram illustrating an example of a hardware configuration of the robot 100. As illustrated in FIG. 2, the robot 100 includes a central processing unit (CPU) 100A that serves as a hardware processor, a random-access memory (RAM) 100B, a read-only memory (ROM) 100C, a non-volatile memory (NVM) 100D, and a network interface (I/F) 100E.

The robot 100 includes the sensor 100F, the camera 100G, a motor 100H, the display 100I, and a speaker 100J. For example, the camera 100G includes a lens and an image sensor such as a complementary metal oxide semiconductor (CMOS) or a charge coupled device (CCD). A touch panel (or a touch sensor) or a microphone may be included in the robot 100. The CPU 100A to the speaker 100J are coupled to each other by an internal bus 100K. For example, the robot 100 may be implemented by a computer (information processing apparatus). Instead of the CPU 100A, a microprocessor unit (MPU) may be used as a hardware processor. Since the robot 100 includes the motor 100H, the head and arm portions of the robot 100 may be moved by controlling the operation of the motor 100H by the CPU 100A.

In the above-described RAM 100B, a program stored in the ROM 100C or the NVM 100 is temporarily stored by the CPU 100A. When the stored program is executed by the CPU 100A, the CPU 100A implements various types of functions described later. When the stored program is executed by the CPU 100A, the CPU 100A executes various types of processes described later. The program may be configured to perform the process of a flowchart described later.

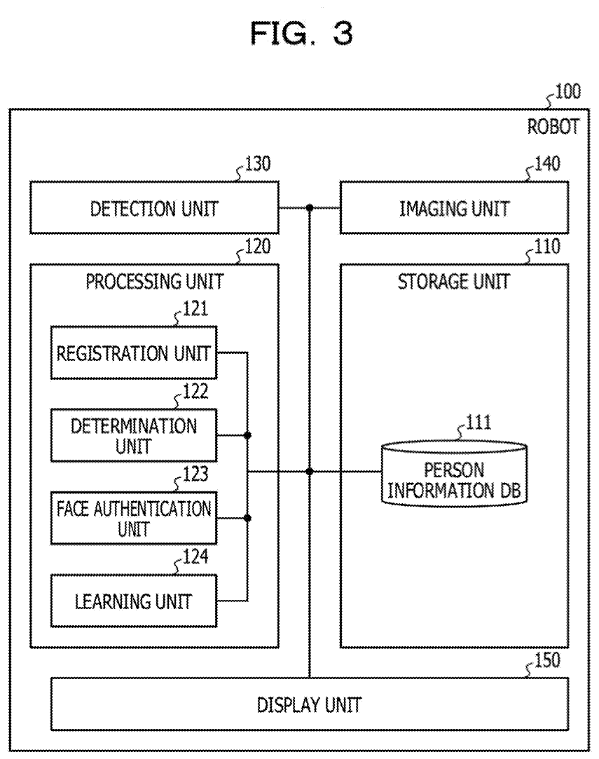

Next, a functional configuration of the robot 100 will be described with reference to FIG. 3.

FIG. 3 is a diagram illustrating an example of a functional configuration of the robot 100. As illustrated in FIG. 3, the robot 100 includes a storage unit 110, a processing unit 120, a detection unit 130, an imaging unit 140, and a display unit 150. The storage unit 110 may be implemented by the RAM 100 and the NVM 100I) described above. The processing unit 120 may be implemented by the CPU 100A described above. The detection unit 130 may be implemented by the sensor 100F described above. The imaging unit 140 may be implemented by the camera 100G described above. The display unit 150 may be implemented by the display 100I described above. Therefore, the storage unit 110, the processing unit 120, the detection unit 130, the imaging unit 140, and the display unit 150 are coupled to each other.

The robot 100 may include a communication unit that may be implemented by the network I/F 100E described above. The robot 100 may include a sound input unit that may be implemented by the microphone described above. The robot 100 may include an operation input unit that may be implemented by the touch panel described above with respect to the robot 100.

The storage unit 110 includes a person information database (DB) 111 as a component. The processing unit 120 includes a registration unit 121, a determination unit 122, a face authentication unit 123, and a learning unit 124 as components. Each component of the processing unit 120 accesses the person information DB 111, which is a component of the storage unit 110, to execute various processes. For example, the face authentication unit 123 executes a face authentication process based on an image of a face of the person 10 imaged as a still image by the imaging unit 140. The detailed description of each component will be described in detail with reference to the operation of the robot 100.

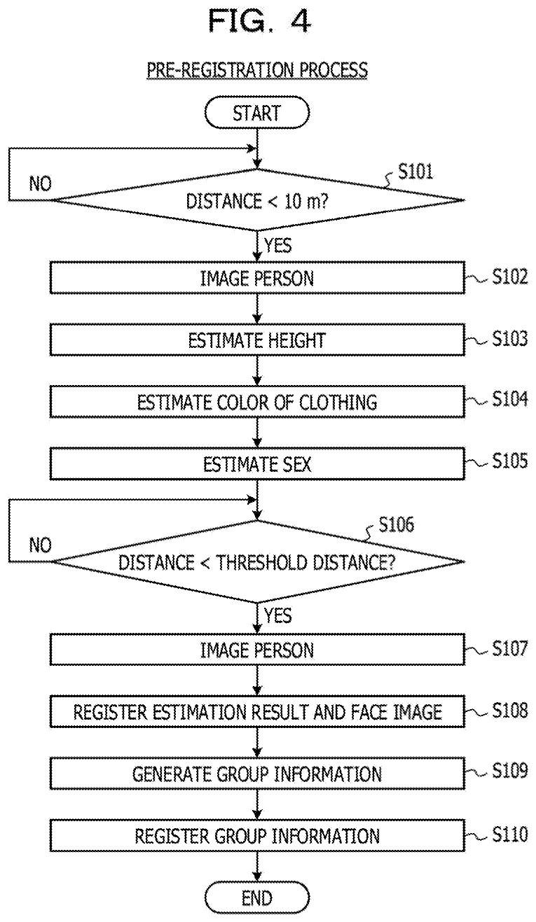

Next, operations of the robot 100 will be described with reference to FIGS. 4 to 12.

First, the pre-registration process executed by the registration unit 121 and the like will be described with reference to FIGS. 4 to 7. The pre-registration process is a process for registering various pieces of information in the person information DB 111 before the face authentication process is performed. First, as illustrated in FIG. 4, the registration unit 121 waits until the distance between the detection unit 130 and the person 10 is less than 10 m (step S101: NO). More specifically, the detection unit 130 continuously or intermittently detects a distance between itself and the person 10 approaching itself, and periodically or intermittently outputs the detected distance as a detected distance to the registration unit 121. The registration unit 121 determines whether or not the detected distance is less than 10 m based on the detected distance output from the detection unit 130. For example, the registration unit 121 determines whether or not the person 10 approaching the robot 100 has reached within the range of 10 m from the robot 100.

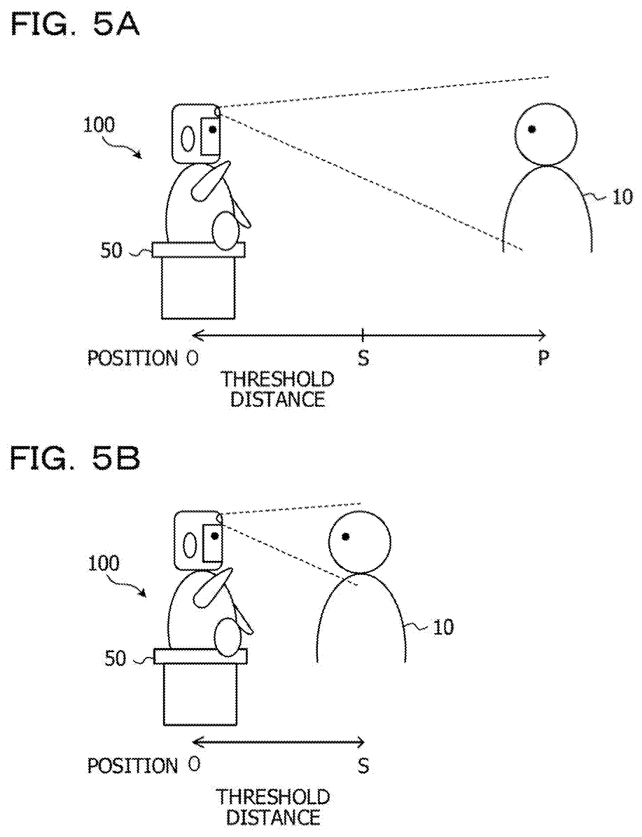

When it is determined that the distance between the detection unit 130 and the person 10 is less than 10 m (step S101: YES), the registration unit 121 images the person 10 as a face authentication target person (step S102). More specifically, as illustrated in FIG. 5A, when it is determined that the detected distance is less than 10 m, the registration unit 121 outputs an imaging command to the imaging unit 140. In the present embodiment, the distance from a position O to a position P corresponds to 10 m. Thus, the imaging unit 140 images the front of the person 10 standing at the position P approximately 10 m away from the position O of the robot 100. In this case, the imaging unit 140 may image not only the face of the person 10 but also a part or the whole of the upper body of the person 10. The imaging unit 140 may image a part or the whole of the lower body together with the upper body of the person 10. For example, the imaging unit 140 may image the whole body of the person 10. When imaging the person 10, the imaging unit 140 outputs the captured image including the person 10 to the registration unit 121 as the first captured image.

After the process in step S102 is completed, the registration unit 121 then estimates the height (step S103). More specifically, when the first captured image is output from the imaging unit 140, the registration unit 121 estimates the height of the person 10 based on the position of the face of the person 10 included in the first captured image and the distance from the position O to the position P. When estimating the height, the registration unit 121 may also estimate the type of the body shape (for example, shape of the body) of the person 10. For example, the registration unit 121 may estimate the type of the body shape, such as lean, normal, and fat, based on the upper body, the whole body, or the like of the person 10 included in the first captured image. When estimating the height, the registration unit 121 holds the estimated height as a first estimation result.

When the process in step S103 is completed, the registration unit 121 then estimates the color of clothing (step S104). More specifically, the registration unit 121 estimates the color preference of the clothing of the person based on the clothing worn by the person 10 included in the first captured image. For example, when the majority of clothing is black, the registration unit 121 estimates the color preference of the clothing of the person 10 as black. When estimating the color of clothing, the registration unit 121 may estimate the type of clothing. For example, when the clothing worn by the person 10 is a uniform of the company to which the person 10 belongs, the registration unit 121 estimates that the type of the clothing of the person 10 is a uniform. The type of clothing may be a suit, a trousers, a skirt, a work clothing, or the like, and is not limited, for example. When estimating the color of clothing, the registration unit 121 holds the estimated color of the clothing as a second estimation result.

When the process in step S104 is completed, the registration unit 121 then estimates the sex (step S105). More for example, the registration unit 121 estimates the sex of the person 10 based on the shape (for example, the contour) of the face of the person 10 included in the first captured image. The registration unit 121 may estimate the sex of the person 10 based on the eye shape or the eye size of the person 10. The registration unit 121 may estimate the sex of the person 10 based on both the shape of the face and the shape of the eye. When estimating the sex, the registration unit 121 holds the estimated sex as a third estimation result.

When the process in step S105 is completed, the registration unit 121 waits until the distance between the detection unit 130 and the person 10 becomes less than the threshold distance (step S106: NO). More specifically, the detection unit 130 continues to detect the distance between itself and the person approaching itself, and outputs the detected distance to the registration unit 121 as a detected distance. The registration unit 121 determines whether or not the detected distance is less than the threshold distance from the robot 100 based on the detected distance output from the detection unit 130. Accordingly, the registration unit 121 determines whether or not the person 10 approaching the robot 100 has reached within the range of the threshold distance from the robot 100. In the present embodiment, 1 m is adopted as the threshold distance, but if the image of the face of the person 10 is within a range that may be imaged with high accuracy, the threshold distance may be increased or decreased from 1 m.

When determining that the distance between the detection unit 130 and the person 10 is less than the threshold distance (step S106: YES), the registration unit 121 images the person 10 (step S107). More specifically, as illustrated in FIG. 5B, when it is determined that the detected distance is less than the threshold distance, the registration unit 121 outputs an imaging command to the imaging unit 140. Thus, the imaging unit 140 images the face of the person 10 standing in the vicinity of the position S which is separated from the position O of the robot 100 by a threshold distance. In this case, the imaging range becomes narrower than that in the case where the person 10 stands in the vicinity of the position P, so that the face of the person 10 may be imaged with high accuracy. For example, in the case of the person 10 standing in the vicinity of the position P, although it is possible to perform imaging such that features other than that of the face of the person 10 may be determined, as for the feature of the face, the imaging accuracy is deteriorated as compared with the case in the vicinity of the position S. When the face of the person 10 is imaged, the imaging unit 140 outputs the captured image including the face of the person 10 to the registration unit 121 as a second captured image.

When the process in step S107 is completed, the registration unit 121 registers the estimation result and the face image (step S108). More for example, the registration unit 121 generates a person ID for identifying the person 10. The registration unit 121 registers the person information including the generated person ID, the first estimation result, the second estimation result, the third estimation result, and the second reference information associated with the face image included in the second captured image, in the person information DB 111. As a result, the person information DB 111 stores the person information.

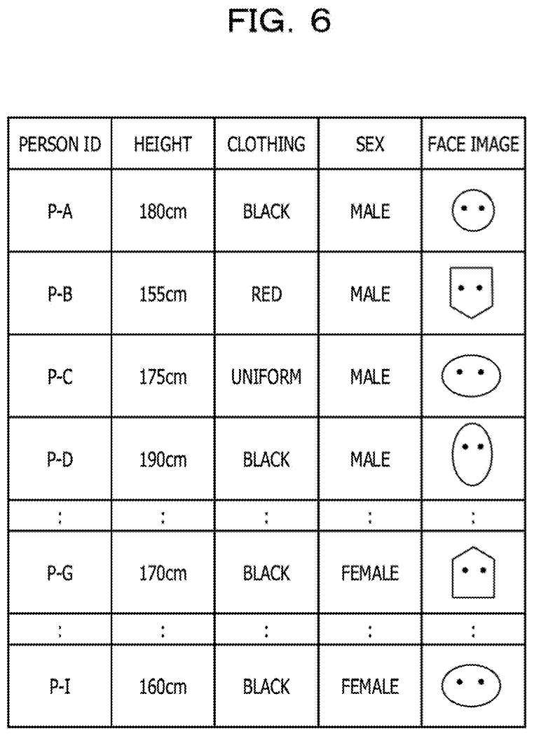

For example, when the registration unit 121 generates a person ID “P-A”, as illustrated in FIG. 6, the person information DB 111 stores person information including the person ID “P-A” and a plurality of estimation results. For example, when the person information DB 111 already stores a plurality of pieces of person information from the person ID “P-B” to the person ID “P-I”, the person information DB 111 newly stores the person information including the person ID “P-A”.

When registering a plurality of estimation results and face images, the registration unit 121 may include an image (for example, a whole body image and the like) of the person 10 included in the first captured image in the second reference information. After the registration unit 121 registers the face image, the learning unit 124 may execute machine learning on each of the height, the clothing color, and the face image. In this case, it is desirable to register a plurality of (desirably, many) height, clothing color, and face image in order to improve learning accuracy of machine learning. Thus, the feature amount of height, the feature amount of clothing color, and the feature amount of face image may be extracted. The learning unit 124 may associate each feature amount extracted in this manner with the corresponding second reference information. For example, an average value of height may be used as the feature amount of height. The feature amount of the color of clothing includes, for example, the ratio of colors and the like appearing in clothing. The feature amount of the face image includes, for example, the shape of the face, the position of the end point of the eye or the eyebrows, and the like.

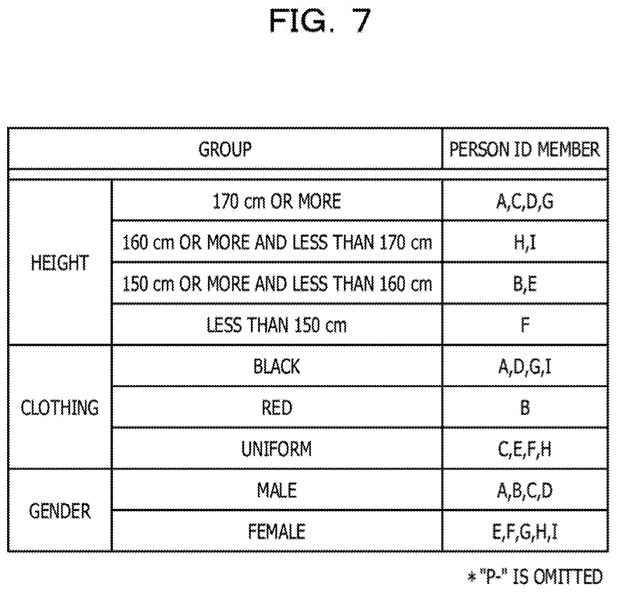

When the process in step S108 is completed, the registration unit 121 generates group information (step S109), and registers the generated group information in the person information DB 111 (step S110). More specifically, the registration unit 121 acquires a plurality of pieces of person information stored in the person information DB 111, and classifies a plurality of person IDs based on the height, clothing, and sex, respectively. For example, with respect to the height, the registration unit 121 classifies a plurality of person IDs into a range of four heights set in advance. When a plurality of person IDs are classified, as illustrated in FIG. 7, the registration unit 121 generates group information relating to the height of the group information. The same as those of the height applies to the clothing and sex. When each group information related to the height, clothing, and sex is generated, the registration unit 121 includes the first reference information associated with each generated group information in the above-described person information. Thus, the person information includes the first reference information together with the second reference information. The person information DB 111 stores such person information. In the person ID member illustrated in FIG. 7, characters and symbols “P-” included in the person ID are omitted.

When the process in step S110 is completed, the registration unit 121 ends the pre-registration process. In the pre-registration process, the height, the color preference of clothing, and sex are estimated, but when the robot 100 has an operation input unit, the height, the color preference of clothing, and sex may be registered by the operation of the person 10. When the robot 100 has a sound input unit, the height, the color preference of the clothing, and the sex of the person may be registered by the voice uttered by the person 10. When the depth sensor is provided in the robot 100, the height and sex may be estimated based on the three-dimensional shape detected by the depth sensor.

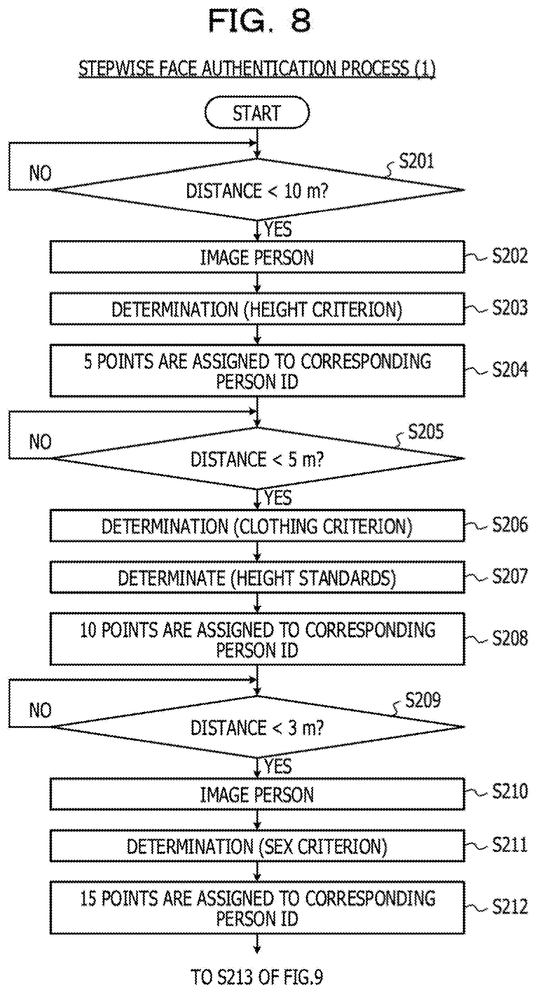

Next, the stepwise face authentication process executed by the determination unit 122, the face authentication unit 123, and the like will be described with reference to FIGS. 8 to 12. The stepwise face authentication process is a process of determining features other than that of the face stepwise before performing the face authentication process to narrow down the face images to be matched with the face image to be authenticated. The authentication speed of the final face authentication may be improved by the stepwise face authentication process.

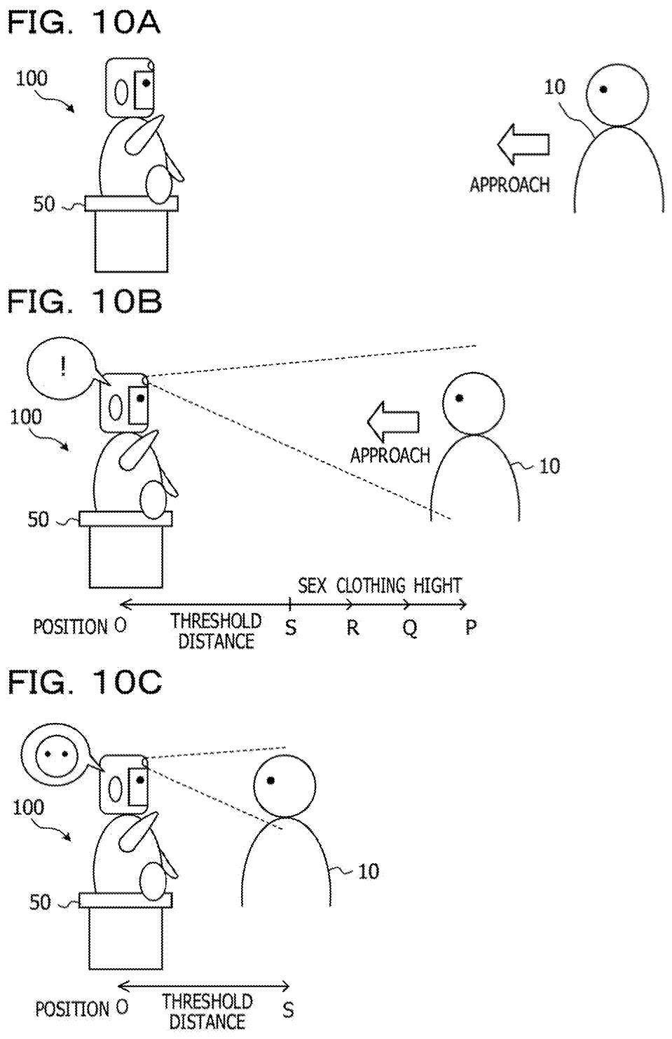

First, as illustrated in FIG. 8, the determination unit 122 waits until the distance between the detection unit 130 and the person 10 is less than 10 m (step S201: NO). More specifically, as illustrated in FIG. 10A, when the person 10 approaches the robot 100, the determination unit 122 waits until the detected distance is less than 10 m. Since the process in step S201 is basically the same as the process in step S101, the detailed description thereof will be omitted.

When determining that the distance between the detection unit 130 and the person 10 is less than 10 m (step S201: YES), the determination unit 122 images the person 10 as a face authentication target person (step S202). More specifically, as illustrated in FIG. 10, when determining that the detected distance is less than 10 m, the determination unit 122 outputs an imaging command to the imaging unit 140. Thus, the imaging unit 140 images the front of the person 10 standing in the vicinity of the position P approximately 10 m away from the position O of the robot 100. In this case, as in the case of the pre-registration process, the imaging unit 140 may image not only the face of the person 10 but also the upper body, the whole body, and the like of the person 10. When imaging the person 10, the imaging unit 140 outputs the captured image including the person 10 to the determination unit 122 as the third captured image.

When the process in step S202 is completed, the determination unit 122 determines whether or not the person 10 satisfies the height criterion (step S203). More specifically, when the third captured image is output from the imaging unit 140, the determination unit 122 estimates the height of the person based on the position of the face of the person 10 included in the third captured image and the distance from the position O to the position P. When estimating the height, the determination unit 122 may also estimate the type of the body shape of the person 10 (for example, the shape of the body). When estimating the height, the determination unit 122 acquires person information from the person information DB 111, and sequentially determines which height criterion group of the first reference information related to the height is satisfied by the estimated height. For example, when the estimated height is 180 cm (centimeter), the determination unit 122 determines that the height criterion (see FIG. 7) of the group of 170 cm or more is satisfied. On the other hand, the determination unit 122 determines that none of the height criteria of the three groups less than 170 cm is satisfied.

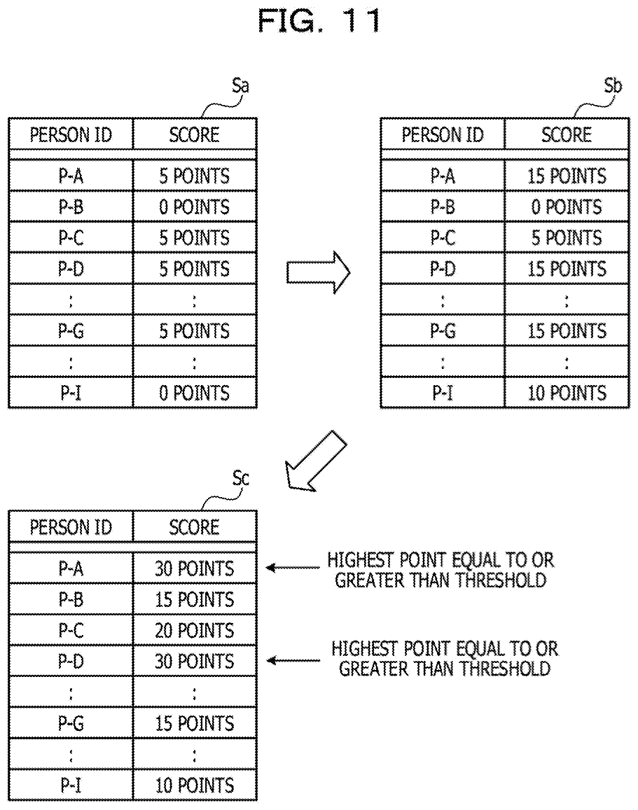

After the process in step S203 is completed, the determination unit 122 then assigns five points to the corresponding person ID (step S204). For example, as illustrated in the score Sa in FIG. 11, the determination unit 122 assigns five points to the person IDs “P-A”, “P-C”, “P-D”, and “P-G” (see FIG. 7) belonging to the height criterion of the group having a height of 170 cm or more. By assigning a score to the corresponding person ID as described above, a candidate of the person ID of the person 10 as a face authentication target person is narrowed down from among a plurality of person IDs.

When the process in step S204 is completed, the determination unit 122 waits until the distance between the detection unit 130 and the person 10 is less than 5 m (step S205: NO). More specifically, as illustrated in FIG. 10, the person 10 further approaches to the robot 100, and the determination unit 122 waits until the detected distance is less than 5 m. In the present embodiment, the distance from the position O to the position Q corresponds to 5 m.

When determining that the distance between the detection unit 130 and the person 10 is less than 5 m (step S205: YES), the determination unit 122 images the person 10 (step S206). More specifically, as illustrated in FIG. 108, when determining that the detected distance is less than 5 m, the determination unit 122 outputs an imaging command to the imaging unit 140. Thus, for example, the imaging unit 140 images the front of the person 10 standing in the vicinity of the position Q. When imaging the person 10, the imaging unit 140 outputs the captured image including the person 10 to the determination unit 122 as the fourth captured image.

When the process in step S206 is completed, the determination unit 122 then determines whether or not the person 10 satisfies the clothing criterion (step S207). More specifically, when the fourth captured image is output from the imaging unit 140, the determination unit 122 estimates the color preference of the clothing of the person 10 based on the clothing worn by the person 10 included in the fourth captured image. In estimating the color of clothing, the determination unit 122 may estimate the type of clothing described above. When estimating the color preference of clothing, the determination unit 122 acquires the person information from the person information DB 111, and sequentially determines which clothing criterion group of the first reference information related to the clothing is satisfied by the estimated color preference of the clothing. For example, when the color preference of the estimated clothing is black, the determination unit 122 determines that the clothing criterion (see FIG. 7) of the black group is satisfied. On the other hand, the determination unit 122 determines that neither of the clothing criterion of the two groups other than black is satisfied.

After the process in step S207 is completed, the determination unit 122 assigns 10 points to the corresponding person ID (step S208). For example, as illustrated by the score Sb in FIG. 11, the determination unit 122 assigns (for example adds) 10 points to the person IDs “P-A”, “P-D”, “P-G”, and “P-I” (see FIG. 7) belonging to the clothing criterion of the black group. By assigning a score to the corresponding person ID as described above, the candidate of the person ID of the face authentication target person 10 is further narrowed down out of the plurality of person IDs.

When the process in step S208 is completed, the determination unit 122 waits until the distance between the detection unit 130 and the person 10 is less than 3 m (step S209: NO). More specifically, as illustrated in FIG. 108, the person 10 further approaches to the robot 100, and the determination unit 122 waits until the detected distance is less than 3 m. In the present embodiment, the distance from the position O to the position R corresponds to 3 m.

When determining that the distance between the detection unit 130 and the person 10 is less than 3 m (step S209: YES), the determination unit 122 images the person 10 (step S210). More specifically, as illustrated in FIG. 108, when determining that the detected distance is less than 3 m, the determination unit 122 outputs an imaging command to the imaging unit 140. Thus, for example, the imaging unit 140 images the front of the person 10 standing in the vicinity of the position R. When imaging the person 10, the imaging unit 140 outputs the captured image including the person 10 to the determination unit 122 as the fifth captured image.

When the process in step S210 is completed, the determination unit 122 then determines whether or not the person 10 satisfies the sex criterion (step S211). More specifically, when the fifth captured image is output from the imaging unit 140, the determination unit 122 estimates the sex of the person 10 based on at least one of the shape of the person 10 included in the fifth captured image and the type of clothing worn by the person 10. The shape of the person may be the shape of the face of the person 10 or may be in the shape of a body. When estimating sex, the determination unit 122 acquires person information from the person information DB 111, and sequentially determines which sex criterion group of the first reference information related to the sex is satisfied by the estimated sex. For example, when the estimated sex is male, the determination unit 122 determines that the sex criterion (see FIG. 7) of the male group is satisfied. On the other hand, the determination unit 122 determines that the sex criterion of the female group is not satisfied.

When the process in step S211 is completed, the determination unit 122 then assigns 15 points to the corresponding person ID (step S212). For example, as illustrated in the score Sc in FIG. 11, the determination unit 122 assigns (for example adds) 15 points to the person IDs “P-A”, “P-B”, “P-C”, and “P-D” (see FIG. 7) belonging to the sex criterion of the male group. By assigning a score to the corresponding person ID as described above, the candidate of the person ID of the face authentication target person 10 is further narrowed down out of the plurality of person IDs.

In the present embodiment, three features of height, clothing, and sex are estimated as estimation targets, but the estimation target may be at least one of the three features. Conversely, the estimation target may be four or more features. In the present embodiment, although the inclination according to the distance is provided to the score to be assigned, the inclination may not be provided. However, as the person 10 approaches the robot 100, since it is possible to capture a large image and make the captured image fine, it is desirable to provide an inclination to the score in accordance with the distance. For example, although an image may be captured to the extent that the height of the person 10 may be estimated at the position P, there is a possibility that the color preference of the clothing and sex may not be imaged to the extent that it may be estimated more accurately than in the case of the height. Therefore, it is desirable to provide an inclination to which a high score is assigned in accordance with a distance at which the estimation accuracy is improved. In this manner, in the present embodiment, estimation targets which may be estimated in accordance with the distance are used. The score to be assigned may be appropriately determined according to design or the like, even when the inclination is provided, or when the inclination is not provided.

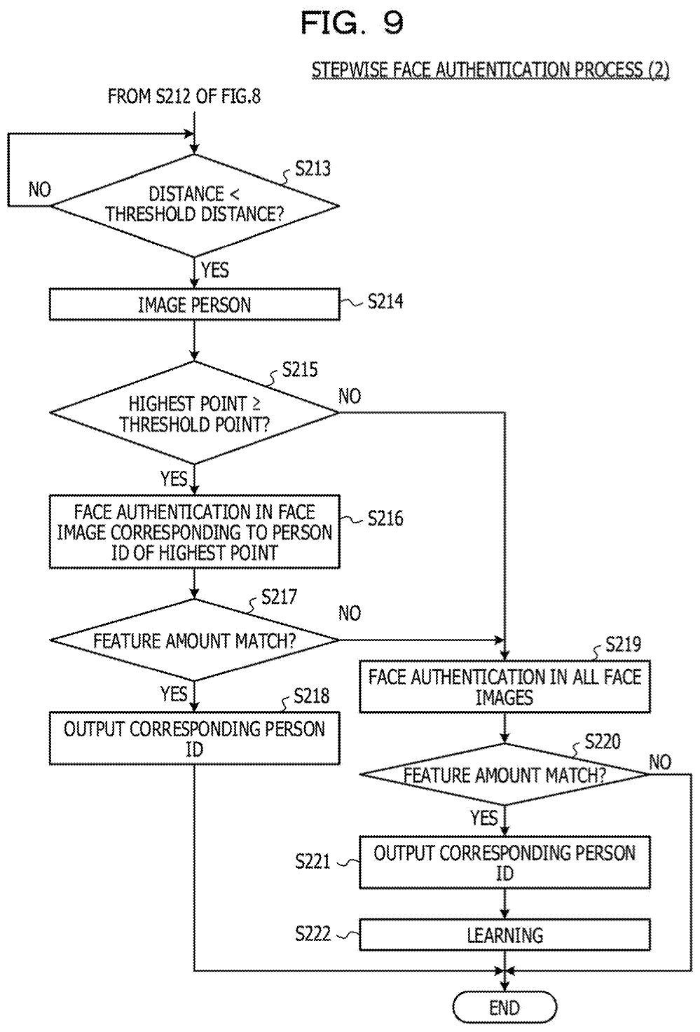

When the process in step S212 is completed, as illustrated in FIG. 9, the determination unit 122 waits until the distance between the detection unit 130 and the person 10 becomes less than the threshold distance (step S213: NO). More specifically, as illustrated in FIG. 10C, the person 10 is further approached to the robot 100, and the determination unit 122 waits until the detected distance is less than the threshold distance. In the present embodiment, the threshold distance from the position O to the position S corresponds to 1 m.

When determining that the distance between the detection unit 130 and the person 10 is less than the threshold distance (step S213: YES), the determination unit 122 images the person 10 (step S214). More specifically, as illustrated in FIG. 10C, when determining that the detected distance is less than the threshold distance, the determination unit 122 outputs an imaging command to the imaging unit 140. Thus, for example, the imaging unit 140 images the face of the person 10 standing in the vicinity of the position S. When the face of the person 10 is imaged, the imaging unit 140 outputs the captured image including the face of the person 10 to the face authentication unit 123 as the face image to be authenticated. For example, since the person 10 stands on the robot 100 side based on the position S, the face of the person 10 may be imaged with high accuracy as compared with a case where the person is standing on the side away from the robot 100 based on the position S.

When the process in step S214 is completed, the determination unit 122 then determines whether the highest point is equal to or greater than the threshold point (step S215). In this manner, the face authentication process described later is performed after the differentiation is fully performed with features other than that of the face. In the present embodiment, 25 points are used as an example of a threshold point, but the threshold point may be determined as appropriate according to the design of the robot 100, the use environment of the robot 100, or the like. As illustrated in the score Sc, since the highest point is 30 points, the determination unit 122 determines that the highest point is equal to or more than the threshold point (step S215: YES).

In this case, the face authentication unit 123 executes face authentication process on a face image corresponding to the person ID of the highest point (step S216), and determines whether or not the feature amount matches (step S217). For example, the face authentication unit 123 executes face authentication process with the feature amount of the face image (see FIG. 6) corresponding to the person ID “P-A” and the person ID “P-D”. Therefore, the threshold distance may be referred to as a distance for changing a feature to be determined. The face authentication process first calculates the matching ratio between feature amounts of the face image to be authenticated and feature amounts of face images corresponding to the person ID “P-A” and the person ID “P-D”. After that, when the calculated matching ratio exceeds a predetermined value, it is determined that the feature amounts of the two face images match. Based on the shape of the face of the person 10 according to the present embodiment, when the face authentication unit 123 calculates the matching ratio between the feature amount of the face image to be authenticated and the feature amount of the face image of the person ID “P-A”, there is a high possibility that the matching ratio of the feature amount exceeds the predetermined value. On the contrary, when the face authentication unit 123 calculates the matching ratio between the feature amount of the face image to be authenticated and the feature amount of the face image of the person ID “P-D”, there is a high possibility that the matching ratio of the feature amount does not exceed the predetermined value.

Therefore, the face authentication unit 123 determines that the feature amounts match by finding a face image with the matching feature amount (step S217: YES), outputs the corresponding person ID (step S218), and ends the process. For example, the face authentication unit 123 outputs the person ID “P-A” to the display unit 150. When the above-described communication unit is coupled to the face authentication unit 123, the face authentication unit 123 may output the person ID “P-A” to the communication unit. When outputting the person ID, the face authentication unit 123 may output a face image and the like associated with the person ID.

On the other hand, when the determination unit 122 determines in the process in step S215 that the highest point is not equal to or greater than the threshold point (step S215: NO), the face authentication unit 123 executes the face authentication process in all face images of the person information stored in the person information DB (step S219). In the process in step S217, when the determination unit 122 determines that the feature amounts do not match (step S217: NO), the face authentication unit 123 similarly executes the process in step S219. In the process in step S219, the face authentication unit 123 may execute the face authentication process by using all face images of the person information stored in the person information DB 111 in descending order of the scores assigned to the person ID corresponding to the face image. In this way, face authentication is performed with priority given to face images having a high probability that the feature amounts are matched by using the person information stored in the person information DB 111. Therefore, the face authentication process in step S219 as a whole, the processing load is reduced and the processing speed is increased. Alternatively, in step S219, the face authentication unit 123 may execute the face authentication process using a part of face images selected based on the score assigned to the person ID corresponding to the face image among all face images of the person information stored in the person information DB 111. The face image selected here may be, for example, a face image in which the score assigned to the person ID corresponding to the face image is greater than or equal to a predetermined score, or a predetermined number of face images in descending order of the score. Thus, face authentication is executed with priority given to face images with a high probability that the feature amounts are matched, so that the face authentication process in step S219 is performed at a high speed and the processing load is reduced.

When the process in step S219 is completed, the face authentication unit 123 determines whether or not the feature amounts match each other (step S220). For example, the face authentication unit 123 executes face authentication process with the feature amount of the face image (see FIG. 6) corresponding to each of the person ID “P-A” and the person ID “P-I”. When the face authentication unit 123 determines that the feature amounts match by finding a face image having a matching feature amount (step S220: YES), the face authentication unit 123 outputs the corresponding person ID (step S221). Therefore, even if the highest point is less than the threshold point in the process of step S215, the face authentication unit 123 may output the person ID “P-A” to the display unit 150.

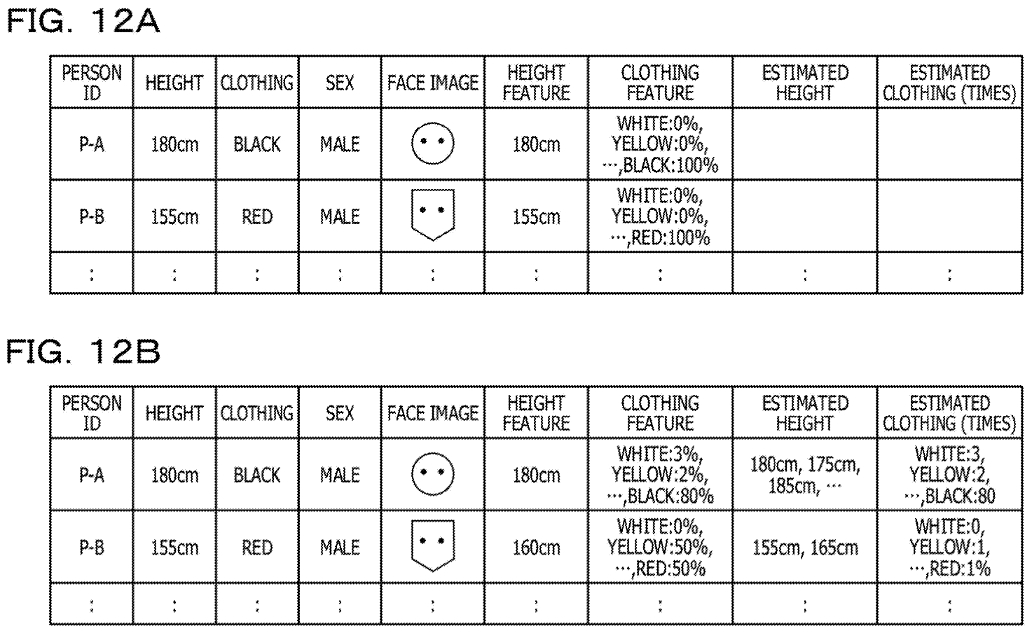

When the process in step S221 is completed, the learning unit 124 learns each feature amount of the height, the color of clothing, and the face image (step S222), and ends the process. For example, the learning unit 124 corrects each feature amount in preparation for the next authentication opportunity. For example, as illustrated in FIGS. 12A and 12B, when the height feature amount (hereinafter referred to as height feature) is associated with the second reference information, the learning unit 124 corrects the height feature. In this case, in the height field, the height input by the operation at the time of the pre-registration process is registered instead of the height estimated by the pre-registration process. The registered height is not a correction target. The registered height is copied to be registered in the field of the height feature.

When the feature amount of the clothing color (hereinafter, referred to as “clothing feature”) is associated with the second reference information, the learning unit 124 corrects the clothing feature. In this case, in the clothing field, the color of clothing input by the operation at the time of the pre-registration process is registered instead of the color of the clothing estimated in the pre-registration process. The color of the registered clothing is not a correction target. The color of the registered clothing is then machine-learned and registered in the field of the clothing feature. In the present embodiment, the clothing feature is represented in the RGB format. As a result, for example, black may be represented as “RGB”=“000:000:000”.

Specifically explaining the learning of the feature amount, when the person 10 may be identified as the person in the face authentication, as illustrated in FIG. 128, the estimated height is registered in the field of the estimated height up to the registration limit number each time. Similarly, when the person 10 may be identified as the person himself or herself in the face authentication, the appearance frequency of the estimated color of the clothing is counted each time, and is registered in the corresponding color of the field of the estimated clothing.

When the learning unit 124 learns the height feature, the learning unit 124 calculates an average value of height registered in the field of estimated height, and corrects height registered in the field of height feature based on the calculated average value. For example, the learning unit 124 overwrites the height registered in the field of the height feature with the calculated average value. Thus, for example, in the case of the person ID “P-B”, the height feature is corrected from 155 cm to 160 cm before and after learning. Thus, when group information is newly generated, the first reference information associated with the group information is updated. For example, the criterion of the height, which is one of the features other than that of the face, changes. When the estimated height deviates from the average value by several tens of centimeters or more, the abnormality of the detection unit 130 is suspected, and therefore, this height may be excluded from the calculation target of the average value.

On the other hand, when the learning unit 124 learns the clothing feature, the learning unit 124 calculates the appearance probability of each color based on the appearance frequency of each color registered in the field of the estimated clothing. The learning unit 124 corrects the clothing feature registered in the field of the clothing feature with the calculated appearance probability. For example, the learning unit 124 overwrites the clothing feature registered in the field of the clothing feature with the calculated appearance probability. Thus, for example, in the case of the person ID “P-A”, the clothing feature is corrected from black 100% to white 3%, yellow 2%, black 80%, and so on. Thus, when group information is newly generated, the first reference information associated with the group information is updated. For example, the criterion of clothing, which is one of the features other than that of the face, changes. In the case where a plurality of colors are corrected as described above, the person ID may be included in each group of colors. For example, the person ID “P-A” may be included in each group of white, yellow, and black.

In the process in step S220 described above, when the face authentication unit 123 determines that the feature amounts do not match because the face image with the matching feature amount is not found (step S220: NO), the face authentication unit 123 ends the process. In this case, the face authentication unit 123 may execute the error process. For example, the face authentication unit 123 may generate notification information for notifying that the corresponding person ID is not found, and may output the notification information to the display unit 150.

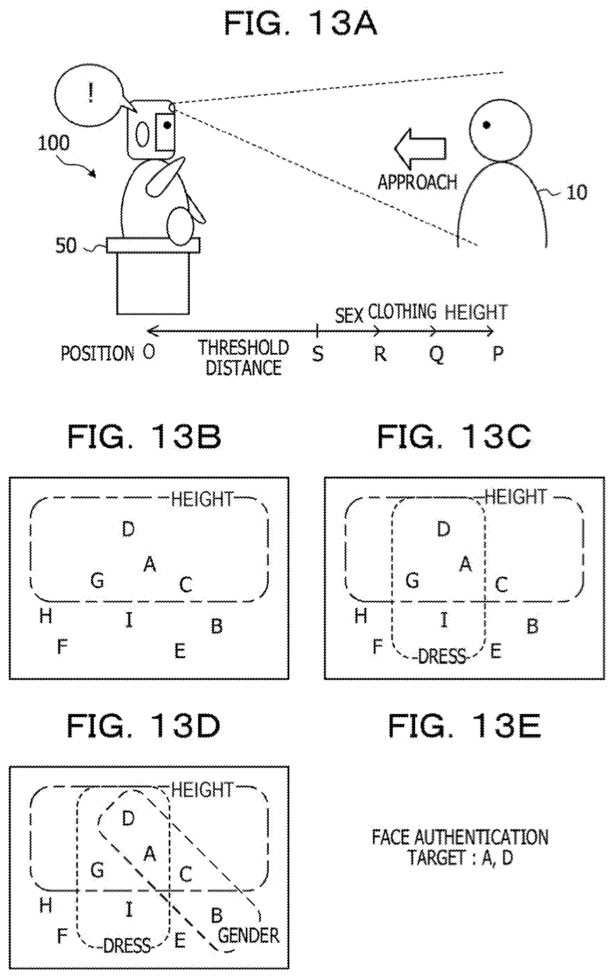

FIGS. 13A to 13E are diagrams for explaining an example of the concept of the stepwise face authentication process. In FIGS. 13B to 13E, characters and symbols “P-” included in the person ID are omitted.

As illustrated in FIG. 13A, when the person 10 approaches the robot 100 gradually, the robot 100 images the person 10 at a time point when the person 10 exceeds the position P. Then, the robot 100 estimates the height of the person 10 based on the captured image, and narrows down the person ID corresponding to the estimated height from among the plurality of person IDs, as illustrated in FIG. 138. In the present embodiment, the candidates are narrowed down to the person IDs “P-A”, “P-C”, “P-D”, and “P-G”.

Thereafter, as illustrated in FIG. 13A, when the person 10 further approaches the robot 100, the robot 100 images the person 10 at the time point when the person 10 exceeds the position Q. The robot 100 estimates the color preference of the clothing of the person 10 based on the captured image, and narrows down the person ID corresponding to the estimated preference among the plurality of person IDs, as illustrated in FIG. 13C. In the present embodiment, the character IDs are narrowed down to the person IDs “P-A”, “P-D”, “P-G”, and “P-I”. For example, the height is narrowed down to the person IDs “P-A”, “P-D”, and “P-G” in consideration of the height of the person 10.

Thereafter, as illustrated in FIG. 13A, when the person 10 further approaches the robot 100, the robot 100 images the person 10 at a time point when the person 10 exceeds the position R. The robot 100 estimates the sex of the person 10 based on the captured image, and narrows down the person ID corresponding to the estimated sex from among a plurality of person IDs, as illustrated in FIG. 13D. In the present embodiment, the candidates are narrowed down to the person ID “P-A”, “P-B”, “P-C”, and “P-D”. For example, in consideration of the height and the color preference of clothing, the candidates are narrowed down to the person IDs “P-A” and “P-D”.

Thereafter, as illustrated in FIG. 13A, when the person 10 further approaches the robot 100, the robot 100 images the face of the person 10 at a time point the person 10 exceeds the position S. Since the distance between the robot 100 and the person 10 is shorter than the distance the person 10 exceeds the position S, the robot 100 may accurately image the face of the person. The robot 100 executes the face authentication process of the person 10 based on the face image of the captured face. For example, the robot 100 narrows down the face image to be matched with the face image to be authenticated to face images of the person IDs “P-A” and “P-D”. Accordingly, the authentication speed of face authentication may be improved.

As described above, according to the first embodiment, the robot 100 includes the storage unit 110 and the processing unit 120. For example, the storage unit 110 includes the person information DB 111. The processing unit 120 includes the determination unit 122 and the face authentication unit 123. The person information DB 111 stores person information. The person information includes first reference information for determining features other than that of the face of each person for each of a plurality of persons. The person information includes second reference information for determining the features of the face of each person for each of a plurality of persons.

On the other hand, when the detected distance from the sensor 100F detected by the sensor 100F to the person 10 is equal to or greater than the threshold distance, the determination unit 122 determines whether or not the person 10 satisfies the first reference information for each of the plurality of persons. The threshold distance is a distance for changing a feature to be determined. When the determination unit 122 determines that the detected distance reaches less than the threshold distance, the face authentication unit 123 executes the face authentication process of the person 10. For example, the face authentication unit 123 executes the face authentication process by preferentially using the second reference information corresponding to the first reference information satisfied by the person 10, with respect to the face image captured by the camera 100G provided in the vicinity of the sensor 100F. Accordingly, the authentication speed of face authentication may be improved. When the number of the face images to be matched increases, the feature amount also increases with respect to the feature amount based on the face image, so that the feature difference may decrease. As a result, although there is a possibility that the authentication accuracy of the face authentication is deteriorated, the face image to be matched is narrowed according to the present embodiment, so that the authentication accuracy may be improved. When the image of the face by the imaging unit 140 is small, there is a possibility that the face feature of the face is not sufficiently obtained, matching accuracy is lowered, and authentication accuracy is lowered. However, according to the present embodiment, since the image is not captured in a state where the face image is small, and the image is captured in a large state, the features of the face may be sufficiently obtained, and the authentication accuracy may be improved.

When the person 10 carries a card for transmitting a radio wave (for example, beacon information and the like) and the robot 100 receives the radio wave, the attribute of the person 10 approaching the robot 100 may be determined by the robot 100. For example, it is also possible to use the beacon information including the ID identifying the employee to determine whether the person 10 approaching the robot 100 is an employee or not. Although the face authentication process using the matching ratio of the feature amounts has been described, the face authentication process may be a process performed by matching face images with each other using a known image matching technique and using the matching result.

### Second Embodiment

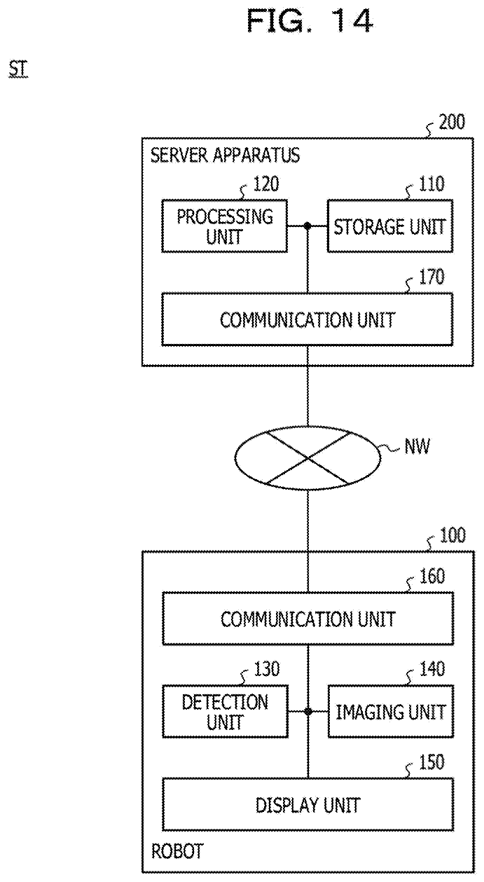

Subsequently, with reference to FIG. 14, a second embodiment of the present disclosure will be described. FIG. 14 is a diagram illustrating an example of an authentication processing system ST. The same configurations of the respective units in the robot 100 illustrated in FIG. 3 are denoted by the same reference numerals, and description thereof is omitted.

The authentication processing system ST includes the robot 100 and a server apparatus 200. The robot 100 is coupled to the server apparatus 200 via a communication network NW. Examples of the communication network NW include a local area network (LAN), the Internet, and the like.

The robot 100 includes the detection unit 130, the imaging unit 140, the display unit 150, and a communication unit 160. On the other hand, the server apparatus 200 includes the storage unit 110, the processing unit 120, and a communication unit 170. The two communication units 160 and 170 may be implemented by the network I/F 100E. As described above, the server apparatus 200 includes the storage unit 110 and the processing unit 120, the server apparatus 200 may serve as an authentication processing apparatus.

As illustrated in FIG. 14, the server apparatus 200, instead of the robot 100, may include the storage unit 110 and the processing unit 120 described in the first embodiment. In this case, the distance detected by the detection unit 130 of the robot 100 and the captured image imaged by the imaging unit 140 are transmitted to the server apparatus 200 via the communication unit 160.

The communication unit 170 of the server apparatus 200 receives the distance and the captured image transmitted from the robot 100, and outputs the received image to the processing unit 120. The processing unit 120 executes various processes described in the first embodiment using the distance and the captured image. The processing unit 120 outputs the processing result to the communication unit 170, and the communication unit 170 transmits the processing result to the communication unit 160. The processing result includes screen information and the like which may display the person ID. Upon receipt of the processing result, the communication unit 160 outputs the screen information to the display unit 150. As a result, the display unit 150 displays a person ID.

As described above, the robot 100 may not include the storage unit 110 and the processing unit 120, but the server apparatus 200 may include the storage unit 110 and the processing unit 120. The server apparatus 200 may include the storage unit 110, and another server apparatus (not illustrated) coupled to the communication network NW may include the processing unit 120. Even in such an embodiment, the authentication speed may be improved.

Although embodiments according to the present disclosure have been described in detail above, the present disclosure is not limited to the specific embodiments, and various modifications and changes may be made within the scope of the present disclosure described in claims.

For example, in the pre-registration process, it has been described that the height, the color preference of clothing, and sex are estimated based on the one captured image. However, the distance from the robot 100 to the person may be subdivided, and the height, the color preference of clothing, and sex may be estimated based on a plurality of captured images captured at the respective distances.

When the distance detected first from the robot 100 is less than the threshold distance, since the various features are not determined, the stepwise face authentication process may be suspended or stopped. Although various features other than that of the face are estimated based on the captured image by the imaging unit 140 in the above-described embodiment, various other features other than that of the face may be estimated based on the three-dimensional shape by the detection unit 130.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
registering, for each of a plurality of persons, person information including first reference information for determining a feature other than that of a face of each person and second reference information for determining a feature of the face of each person in a memory;
determining, when a distance from a sensor to a target person is equal to or greater than a threshold value, whether the target person satisfies a first criterion included in the first reference information for each of the plurality of persons, the distance being detected by the sensor;
capturing, when the distance is less than the threshold value, a first image of the target person by a camera provided in a vicinity of the sensor; and
performing a face authentication process for the target person on the first image preferentially using the second reference information corresponding to the first reference information including a second criterion determined to be satisfied by the target person.

2. The non-transitory computer-readable recording medium according to claim 1, wherein
the second reference information is preferentially used to identify candidates from the plurality of persons, and
the face authentication process is performed by comparing the first image of the target person with person information of each of the candidates.

3. The non-transitory computer-readable recording medium according to claim 2, wherein
when the comparing of the person information of each of the candidates to the first image does not satisfy the second criterion, the face authentication process includes comparing the first image with person information of the plurality of persons other than the candidates.

4. The non-transitory computer-readable recording medium according to claim 1, the process further comprising:
executing machine learning on the first reference information to classify the plurality of person into groups stored within the memory; and
updating the first reference information of the target person, using the machine learning, as additional information is received from the first image.

5. The non-transitory computer-readable recording medium according to claim 1, the process further comprising:
capturing, as the first image, an image of a face of the target person.

6. The non-transitory computer-readable recording medium according to claim 1, the process further comprising:
capturing by the camera, when the distance is equal to or greater than the threshold value, a second image of the target person; and
determining, for the second image, whether the target person satisfies the first criterion included in the first reference information for each of the plurality of persons.

7. The non-transitory computer-readable recording medium according to claim 1, wherein
the first reference information includes a plurality of criteria for different features to be determined, and
the process further comprises:
capturing by the camera, when the distance is equal to or greater than the threshold value, second images of the target person in accordance with the distance; and
determining stepwise, for the second images, whether the target person satisfies the plurality of criteria for each of the plurality of persons.

8. The non-transitory computer-readable recording medium according to claim 7, the process further comprising:
estimating a height of the target person based on a position of the face of the target person included in one of the second images; and
determining whether the estimated height satisfies a criterion for a height in the plurality of criteria.

9. The non-transitory computer-readable recording medium according to claim 7, the process further comprising:
estimating a characteristic of clothing based on the clothing of the target person included in one of the second images; and
determining whether the estimated characteristic satisfies a criterion for clothing in the plurality of criteria.

10. The non-transitory computer-readable recording medium according to claim 7, the process further comprising:
estimating a sex of the target person based on at least one of a shape of the target person and a characteristic of clothing included in one of the second images; and
determining whether the estimated sex satisfies a criterion for a sex in the plurality of criteria.

11. The non-transitory computer-readable recording medium according to claim 1, the process further comprising:
detecting a shape of the target person with a depth sensor; and
determining, when the distance is equal to or greater than the threshold value, whether the target person satisfies the first criterion included in the first reference information for each of the plurality of persons for the shape of the target person.

12. A method of authentication, comprising:
registering by a computer, in a memory of the computer, for each of a plurality of persons, person information including first reference information for determining a feature other than that of a face of each person and second reference information for determining a feature of the face of each person;
determining, when a distance from a sensor to a target person is equal to or greater than a threshold value, whether the target person satisfies a first criterion included in the first reference information for each of the plurality of persons, the distance being detected by the sensor;
capturing, when the distance is less than the threshold value, a first image of the target person by a camera provided in a vicinity of the sensor; and
performing a face authentication process for the target person on the first image preferentially using the second reference information corresponding to the first reference information including a second criterion determined to be satisfied by the target person.

13. An information processing apparatus, comprising:
a memory; and
a processor coupled to the memory and the processor configured to:
register, for each of a plurality of persons, person information including first reference information for determining a feature other than that of a face of each person and second reference information for determining a feature of the face of each person in the memory;
determine, when a distance from a sensor to a target person is equal to or greater than a threshold value, whether the target person satisfies a first criterion included in the first reference information for each of the plurality of persons, the distance being detected by the sensor;
capture, when the distance is less than the threshold value, a first image of the target person by a camera provided in a vicinity of the sensor; and
perform a face authentication process for the target person on the first image preferentially using the second reference information corresponding to the first reference information including a second criterion determined to be satisfied by the target person.

14. The information processing apparatus according to claim 13, wherein
the processor is further configured to:
capture, as the first image, an image of a face of the target person.

15. The information processing apparatus according to claim 13, wherein
the processor is further configured to:
capture by the camera, when the distance is equal to or greater than the threshold value, a second image of the target person; and
determine, for the second image, whether the target person satisfies the first criterion included in the first reference information for each of the plurality of persons.

16. The information processing apparatus according to claim 13, wherein
the first reference information includes a plurality of criteria for different features to be determined, and
the processor is further configured to:
capture by the camera, when the distance is equal to or greater than the threshold value, second images of the target person in accordance with the distance; and
determine stepwise, for the second images, whether the target person satisfies the plurality of criteria for each of the plurality of persons.

17. The information processing apparatus according to claim 16, wherein
the processor is further configured to:
estimate a height of the target person based on a position of the face of the target person included in one of the second images; and
determine whether the estimated height satisfies a criterion for a height in the plurality of criteria.

18. The information processing apparatus according to claim 16, wherein
the processor is further configured to:
estimate a characteristic of clothing based on the clothing of the target person included in one of the second images; and
determine whether the estimated characteristic satisfies a criterion for clothing in the plurality of criteria.

19. The information processing apparatus according to claim 16, wherein
the processor is further configured to:
estimate a sex of the target person based on at least one of a shape of the target person and a characteristic of clothing included in one of the second images; and
determine whether the estimated sex satisfies a criterion for a sex in the plurality of criteria.

20. The information processing apparatus according to claim 13, wherein
the processor is further configured to:
detect a shape of the target person based on information detected by a depth sensor; and
determine, when the distance is equal to or greater than the threshold value, whether the target person satisfies the criterion included in the first reference information for each of the plurality of persons for the shape of the target person
